(19) United States
(12) Patent Application Publication
(10) Pub. No.: US 2014/0149215 A1
(43) Pub. Date: May 29, 2014

(54) DETERMINING KEYWORDS FOR CONTENT ITEMS

(71) Applicants: Giridhar Rajaram, Cupertino, CA (US); Gokul Rajaram, Los Altos, CA (US)

(72) Inventors: Giridhar Rajaram, Cupertino, CA (US); Gokul Rajaram, Los Altos, CA (US)

(21) Appl. No.: 13/689,639

(22) Filed: Nov. 29, 2012

(51) Int. Cl. G06F 15/16; G06F 17/00

(52) U.S. Cl. CPC G06F 15/16; G06F 17/00; G06Q 30/0256
USPC 705/14.54; 709/204; 715/205; 705/14.71

(57) ABSTRACT

A social networking system receives a request to generate a post including a content item from a user and extracts a topic from the content item. Using the extracted topic, the social networking system identifies candidate keywords, each associated with one or more expected values. The social networking system may use information associated with the user to determine the expected values associated with the candidate keywords. Using the expected values, the social networking system ranks the candidate keywords and selects a keyword from the candidate keywords based on the ranking. Based on the selected keyword the social networking system generates a link to content and includes the link to content and the generated content item in the post that is presented to the user.

### BACKGROUND

This disclosure relates generally to social networking systems, and in particular to determining keywords associated with content items posted to a social networking system.

Content items are often provided to a social networking system for distribution using plain text. Users infrequently associate content items with topics or subjects, limiting the social networking system's ability to correlate content items with particular subjects or topics. This also limits the social networking system in presenting subjects or topics associated with a content item in conjunction with the content item.

Additionally, words in a content item may have many meanings, so automated topic recognition may incorrectly determine the meaning of ambiguous words. Different words also having similar meanings may have different click through rates depending on a user's demographic information. Hence, which of the words is associated with a content item may affect user interaction with the content item, and this may affect revenue generated by the social networking system from user interaction with content items.

### SUMMARY

A social networking system receives a request for a post to be presented to the user. The post includes a content item maintained by the social networking system. A topic is extracted from the content item and one or more candidate keywords associated with the extracted topic are identified. The candidate keywords are selected from keywords maintained by the social networking system, with each keyword associated with an expected value.

Based on the expected values associated with the candidate keywords, the candidate keywords are ranked. Using the ranking, a keyword is selected from the candidate keywords and associated with the post. In one embodiment, the social networking system retrieves information describing one or more characteristics of the user requesting the post. The social networking system compares the user information with one or more user categories associated with each candidate keyword, retrieves expected values of candidate keywords associated with a user category based on the user information. For example, expected values associated with a user category having the most attributes satisfied by the user information are retrieved. This allows the expected values used to select a keyword to account for variations in how different categories of users interact with content associated with keywords. Hence, different keywords may be associated with a post when different users request the post because of differences between the users' characteristics.

The social networking system generates a link to content based on the selected keyword, and includes the link to content in the post along with the content item. For example, the social networking system generates a search query including the keyword associated with the content item. The post including the content item and link to content is then presented to the requesting user.

### BRIEF DESCRIPTION OF THE DRAWINGS

FIG. 1 is a an interaction diagram of a process for determining keywords associated with posts in a social networking system, according to one embodiment.

FIG. 2 illustrates a block diagram of a system environment for a social networking system, in accordance with an embodiment.

FIG. 3 is an example of a social networking system, in accordance with an embodiment.

FIG. 4 is a flowchart of a process for determining a keyword associated with a post in a social networking system, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

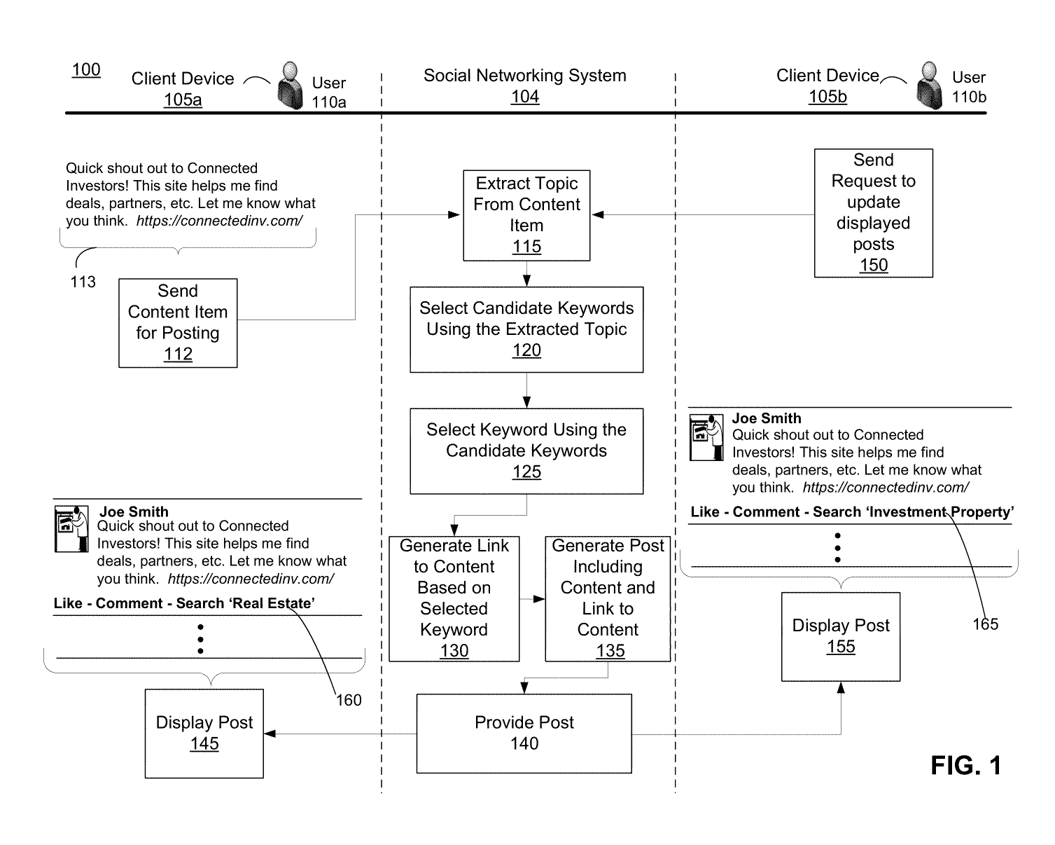

FIG. 1 is an interaction diagram of one embodiment of a process 100 for associating keywords with posts in a social networking system 104. A client device 105a, associated with a user 110a, sends 112 a content item 113 to the social networking system 104 for presentation to other social networking system users. For example, the social networking system 104 generates a post including the content item 113 that is displayed on a profile page associated with the user 110a or associated with another user. Alternatively, the social networking system 104 transmits a message including the content item 113 to one or more users connected to the user 110a or presents the content item 113 to other users via any suitable communication channel. In some embodiments, the user 110a may associate structured information with the content item 113 identifying an action, one or more users, a location, or another object maintained by the social networking system 104. Structured information may be, for example, location information, a name of a business, identification information relating to other users of the social networking system 104, etc.

The social networking system 104 extracts 115 a topic from the content item 113. As used herein, “topic” identifies the definition, the meaning, or the subject matter of the content item 113. For example, the topic of the content item 113 is determined by analyzing text included in the content item 113. In one embodiment, to extract 115 a topic from the content item 113, the social networking system 104 identifies anchor terms included in the content item 113 and determines the meaning of the anchor terms as further described in U.S. application Ser. No. 13/167,701, filed Jun. 24, 2011, and U.S. patent application Ser. No. 13/627,945, filed on Sep. 26, 2012, which are each hereby incorporated by reference in their entirety. In FIG. 1, the social networking system 104 extracts 115 a topic of “Connected Investors®,” a social network for real estate agents, from the content item 113. In some embodiments structured information associated with the content item 113 may be used to identify the topic extracted from the content item 113. For example, if the structured information includes a name of a restaurant having a page or other object maintained by the social networking system 104, the topic extracted from the content item 113 may identify a restaurant.

Using the extracted topic, the social networking system 104 selects 120 one or more candidate keywords. For example, a keyword store includes keywords associated with various topics, and the social networking system 120 selects 120 keywords associated with the extracted topic form the keyword store. A candidate keyword may be a word or phrase associated with the extracted topic by a keyword store. For example, a keyword store associates the topic “Connected Investors®” with the keywords “investment property” and “real estate” and associates another topic with the keywords “restaurants” and “vacation,” so the social networking system 104 selects “investment property” and “real estate” with the extracted topic of “Connected Investors®” in the example of FIG. 1.

Additionally, the keyword store associates each stored keyword with an expected value. In one embodiment, the expected value associated with a keyword is based on a bid price associated with the keyword by one or more advertisers. The bid price may be adjusted by a probability that a user will interact with the keyword, or with content associated with the keyword; hence, the expected value may be a product of a bid price associated with the keyword and a probability a user accesses content associated with the keyword. Alternatively, the expected value is determined based on a number of times users access content associated with the keyword or access the keyword. In another embodiment, the expected value may be based on the number of times a keyword is displayed.

The social networking system 104 selects 125 a keyword from the candidate keywords based at least in part on the expected values associated with the candidate keywords. In one embodiment, the social networking system 104 associates multiple expected values with keywords, with different expected values associated with different categories of users. The social networking system 104 retrieves information associated with a user requesting presentation of a post and compares the user information to user characteristics associated with user categories. For example, a user category is specified by a combination of demographic information, or other information, associated with users. In some embodiments, the user information includes information pertaining to other users of the social networking system 104 who are connected to the user requesting the post. A keyword may be associated with multiple expected values, each corresponding to a user category, to account for different interactions with the keyword by users having different characteristics. A candidate keyword's expected value associated with a user category having the largest number of characteristics satisfied by the user information of the user requesting the post is retrieved. This allows different expected values for candidate keywords to be used based on user information of different users requesting posts.

Based on the expected values associated with the candidate keywords, the candidate keywords are ranked. A candidate keyword is selected 125 based at least in part on the ranking For example, the candidate keyword having the largest expected value is selected 125. In the example of FIG. 1, user information associated with user 110a indicates that user 110a is male, 25 years old, and works as a real estate agent. Based on the user information, social networking system 104 determines a user category for user 110a and retrieves expected values associated with the determined user category for the keywords “real estate” and “investment property.” As shown in FIG. 1, social networking system 104 determines that the expected value associated with the user category of the candidate keyword “real estate” is the largest, and selects 125 “real estate” as the keyword associated with the post.

Alternatively, the social networking system 104 retrieves an expected value for each candidate keywords from a value store using the topic extracted 115 from the content item 113. Each candidate keyword is associated with one or more expected values that are associated with one or more topics. For example, the candidate keywords “investment property” and “real estate” are associated with expected values of, $0.45 and $0.50, respectively, when associated with the topic “Connected Investors®.” However, the candidate keywords “investment property” and “real estate” are associated with different expected values for different topics.

In some embodiments, the social networking system 104 selects a candidate keyword having at least a threshold similarity to the extracted topic, without determining expected values of the candidate keywords. For example, if the topic extracted from a content item is “Marvel: Avengers Alliance” and a candidate keyword matches the topic, the candidate keyword matching the topic is selected. This may allow the user viewing the post to more easily retrieve additional information describing the content item included in a post.

Based on the selected keyword, the social networking system 104 generates 130 a link 160. The link may be a hyperlink to a website associated with the selected keyword. For example, the link may reference an advertisement, or a website associated with the content item of the post. Alternatively, the link may be a hyperlink to a search landing page resulting from a contextual search query generated from the selected keyword. For example, the keyword “real estate” causes social networking system 110 to generate 130 a link 160 to a search landing page resulting from a search using “real estate.” The search landing page identified by the link 160 may include search results as well as one or more advertisements related to the keyword “real estate.” In one embodiment, advertisers may bid for inclusion of their advertisements on the search landing page.

The social networking system 104 generates 135 a post including the content item and the generated link to content and provides 140 the generated post to a client device 105a associated with the user 110a requesting the post. In one embodiment, the link to content is displayed within the generated post. The client device 105a displays the post, which includes the content item and the link 160, to the user 110a.

If the social networking system 104 uses user information to retrieve an expected value the candidate keywords, different keywords may be selected 125 for different users. For example, a client device 105b associated with a user 110b sends 150 a request to the social networking system 104 to update posts displayed on the device 105b or sends 150 a request to view a post from the social networking system 104. User information associated with the user 110b by the social networking system 104 indicates that user 110b is 60 years old and is an investment broker. Hence, the user 110b is in a different user category than the user 110a, and the user category including the user 110b has a highest expected value associated with the candidate keyword “investment property.” The social networking system 104 selects 125 the keyword “investment property” and generates a link 130 based on the keyword “investment property.” Accordingly, the post generated 135 and provided 140 to the client device 105b associated with the user 110b includes a different link 165 to content based on “investment property,” rather than the link 160 to content based on “real estate” generated for user 110a. Hence, the post 155 displayed to the user 110b includes the same content item as the post displayed 145 to the user 110a but includes a different link 165 to content. In some embodiments, the link 160 and the link 165 may be generated based on different selected keywords but link to the same content.

In some embodiments, the social networking system 104 dynamically updates the expected values for the candidate keywords over time. For example, the social networking system 104 monitors whether a user accesses links generated from a candidate keyword and modifies the expected value of the candidate keyword accordingly. Additionally, the social networking system 104 may group and/or update expected values of candidate keywords based on the demographics associated with users accessing links generated from candidate keywords. This allows user category information to be updated. Hence, the social networking system 104 may identify candidate keywords most likely to result in a user accessing a link generated from the candidate keywords based on user information and topic.

### System Architecture

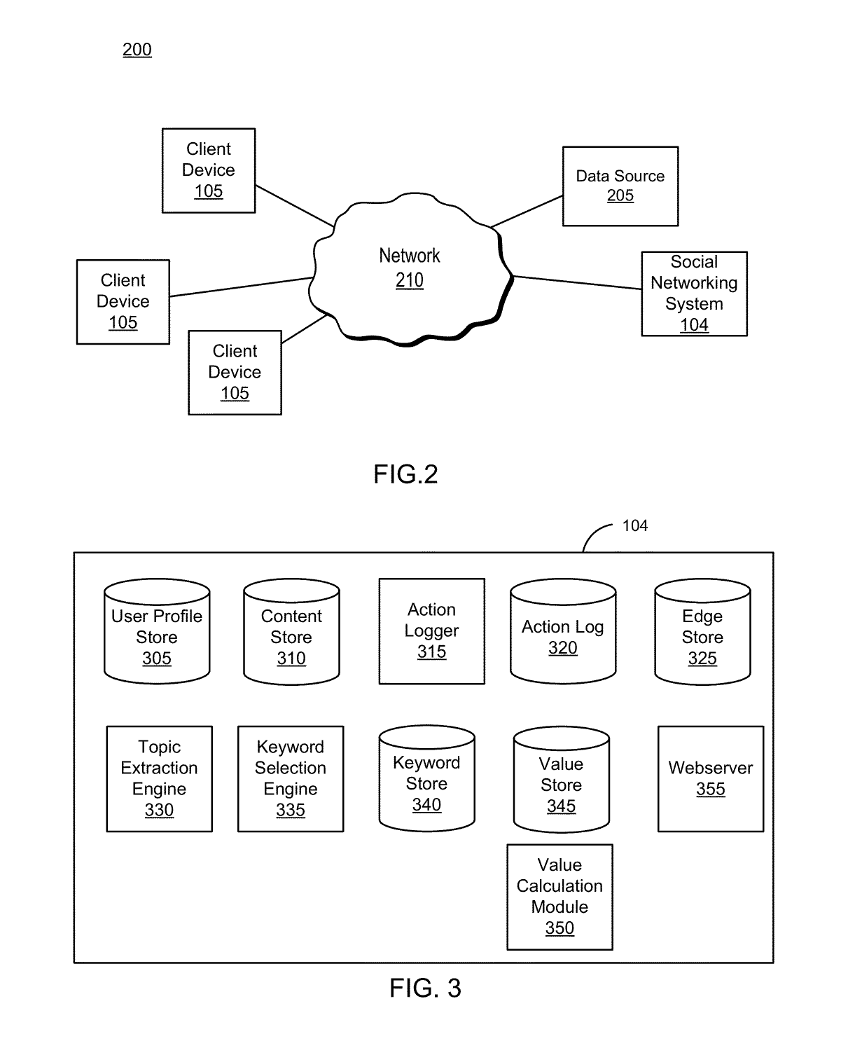

FIG. 2 illustrates a block diagram of one embodiment of a system environment 200 in which the social networking system 104 operates. The system environment 200 includes the social networking system 104, one or more client devices 105, one or more data sources 205, and a network 210. In various embodiments, the system environment 200 may be organized in an alternative topology or configuration, and include different and/or additional modules.

The client devices 105, comprise one or more computing devices capable of processing data as well as transmitting and/or receiving data via the network 210. Examples of a client device 105 include a personal digital assistant (PDA), a mobile telephone, a laptop computer, and a desktop computer. A client device 105 may execute a social networking application that allows a user to exchange data with the social networking system 104 via a client device 105 and the network 210. Alternatively, a social networking system user accesses the social networking system 104 via a browser executing by the client device 105. User identification information for each user of the client device 105 that previously accessed the social networking system 104 may be stored by the requesting client device 105.

The client devices 105 are configured to communicate with the social networking system 104 or other devices via the network 210. In one embodiment, the network 210 uses standard communications technologies and/or protocols. Thus, the network 210 may include wired and/or wireless communication channels using technologies such as Ethernet, 802.11 family of standards, worldwide interoperability for microwave access (WiMAX), 3G, 4G, CDMA, digital subscriber line (DSL), etc. Examples of networking protocols used by the network 210 include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 210 may be represented using technologies and/or formats including hypertext markup language (HTML) and extensible markup language (XML). In addition, all or some of the communication channels may be encrypted using conventional encryption technologies such as secure sockets layer (SSL), transport layer security (TLS), and Internet Protocol security (IPsec). Data sources 205 are coupled to the network 210 and exchange data with one or more client devices 105 and/or with the social networking system 104; examples of data sources 205 include websites, network storage locations, or other suitable source of content.

FIG. 3 is a block diagram of one embodiment of a social networking system 104. In the embodiment shown by FIG. 3, the social networking system 104 includes a user profile store 305, a content store 310, an action logger 315, an action log 320, an edge store 325, a topic extraction engine 330, a keyword selection engine 335, a keyword store 340, a value store 345, a value calculation module 350, and a web server 355. In other embodiments, the social networking system 104 may include additional, fewer, or different modules for various applications. Conventional components such as network interfaces, security functions, load balancers, failover servers, management and network operations consoles, and the like are not shown so as to not obscure the details of the system architecture.

Each user of the social networking system 104 is associated with a user profile, which is stored in the user profile store 305. A user profile includes declarative information about the user that was explicitly shared by the user, and may also include profile information inferred by the social networking system 104. In one embodiment, a user profile includes multiple data fields, each data field describing one or more attributes of the corresponding user of the social networking system 104. Information stored in the user profile store 305 describes the users of the social networking system 104, including biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 104 displayed in an image. A user profile in the user profile store 305 may also maintain references to actions by the corresponding user performed on objects in the content store 310 and stored in the action log 320.

The content store 310 stores content objects. A content object, or “object,” is any type of content maintained by the social networking system 104. Examples of objects include: a posting to a page maintained by the social networking system 104, a status update, a photo, a video, a link, a gaming application achievement, a check-in event at a local business and so on. Content objects include objects created by users of the social networking system 104, such as status updates associated with photo objects, location objects, and other users; photos tagged by users to be associated with other objects in the social networking system 104, such as events, pages, and other users; and applications installed on the social networking system 104. In some embodiments, content objects are received from third-party applications, which may be separate from the social networking system 104. Content “items” represent single pieces of content presented by the social networking system 104. Presenting content items to social networking system users encourage social networking system users to communicate with each other various types of content items through various communication channels, increasing the interaction of users with each other and increasing the frequency with which users interact within the social networking system 104. In some embodiments, the content store 310 includes structured information associated with various content items. Examples of structured information associated with a content item includes location information, a name of a business, identification information relating to other users of the social networking system 104, etc.

The action logger 315 receives communications about user actions on and/or off the social networking system 104. The action logger 315 populates the action log 320 with information about the user actions, allowing the actions to be tracked. Example actions include: adding a connection to another user, sending a message to another user, uploading an image, reading a message from another user, viewing content associated with the other user, attending an event, clicking on a link, among others. In addition, a number of actions described in connection with other objects are directed at particular users, so these actions are associated with those users as well. These actions are stored in the action log 320.

The action log 320 may be used by the social networking system 104 to track users' actions on the social networking system 104 as well as actions on external websites that communicate information back to the social networking system 104, such as a data source 205. Users may interact with various objects on the social networking system 104, including commenting on posts, sharing links, and checking-in to physical locations via a mobile device, or other interactions. Information describing these actions is stored in the action log 320. Additional examples of interactions with objects on the social networking system 104 included in the action log 320 include commenting on a photo album, communicating messages between users, becoming a fan of a musician, joining an event, joining a group, becoming a fan of a brand page, creating an event, authorizing an application, using an application, and engaging in a transaction. Hence, the action log 320 records a user's interactions with advertisements on the social networking system 104, interactions with content items, and interactions with applications operating on the social networking system 104.

The edge store 325 stores information describing connections between users and other objects on the social networking system 104 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 104, such as expressing interest in a page on the social networking system, sharing a link with other social networking system users and commenting on posts made by other users of the social networking system. The edge store 325 includes information describing various edges, such as affinity scores for objects, interests, and other users.

Affinity scores may be computed by the social networking system 104 over time to approximate a user's affinity for an object, interest, and other users in the social networking system 104 based on the actions performed by the user. Computation of affinity scores is further described in U.S. patent application Ser. No. 12/978,265, filed on Dec. 23, 2010, which is hereby incorporated by reference in its entirety. Multiple interactions between a user and a specific object may be stored in one edge in the edge store 325, in one embodiment or may be stored as multiple edges. In some embodiments, connections between users and objects may be stored in the content store 310 with connections between users stored in the user profile store 305 or the content store 310.

The social networking system 104 includes a topic extraction engine 330, which identifies one or more topics associated with objects in the content store 310. To identify topics associated with content items, the topic extraction engine 330 identifies anchor terms included in a content item and determines a meaning of the anchor terms as further described in U.S. application Ser. No. 13/167,701, filed Jun. 24, 2011, which is hereby incorporated by reference in its entirety. For example, the topic extraction engine 330 determines one or more topics associated with a content item maintained in the content store 310. The one or more topics associated with a content item are stored and associated with an object identifier corresponding to the content item. In various embodiments, associations between object identifiers and topics are stored in the topic extraction engine 330 or in the content store 310 to simplify retrieval of one or more topics associated with an object identifier or retrieval of object identifiers associated with a specified topic. Structured information associated with a content item may also be used to extract a topic associated with the content item.

The keyword selection engine 335 selects candidate keywords associated with a content item using a topic extracted from the content item by the topic extraction engine 330. The candidate keywords may be retrieved from a keyword store 340. In one embodiment, the keyword store 340 includes multiple keywords and associates one or more topics and one or more expected values with each keyword. Hence, the keyword selection engine 335 retrieves candidate keywords from the keyword store 335 associated with the topic extracted from a content item.

Additionally, the keyword selection engine 335 retrieves one or more expected values for each candidate keyword from the keyword store 340. In one embodiment, the expected values are stored in the keyword store 340. Alternatively, the expected values are stored in a value store 345. The value store 345 stores data associating one or more expected values with keywords. In one embodiment, the value store 345 includes data describing one or more user categories and associates expected values of keywords with one or more user categories. For example, the value store 345 includes data describing one or more characteristics of users corresponding to different user categories. As discussed above in conjunction with FIG. 1 an expected value associated with a keyword is based on a bid price associated with the keyword by one or more advertisers. The bid price may be adjusted by a probability that a user will interact with the keyword, or with content associated with the keyword; hence, the expected value may be a product of a bid price associated with the keyword and a probability a user accesses content associated with the keyword. Alternatively, the expected value is determined based on a number of times users access content associated with the keyword or access the keyword. In another embodiment, the expected value may be based on the number of times a keyword is displayed.

In one embodiment, the keyword selection engine 335 retrieves user information associated with a user requesting a post from one or more of the user profile store 305, the action log 320, and the edge store 325. The keyword selection engine 335 compares the user information to characteristics associated with user categories by the value store 345. Based on the comparison, the keyword selection engine 335 identifies a user category associated with the user. For example, the keyword selection engine 335 associates the user category having the largest number of characteristics satisfied by the user information with the user. The expected value associated with the user category associated with the user is then retrieved.

Alternatively, the keyword selection engine 335 retrieves an expected value for each of the candidate keywords based on an association between the extracted topic and expected values by the value store 345. In some embodiments, if a candidate keyword matches or has at least a threshold similarity to the extracted topic, the keyword selection engine 335 associates the candidate keyword with the content item from which the topic was extracted. The keyword selection engine 335 ranks the candidate keywords using the expected values and selects the candidate keyword using the ranking. For example, the keyword selection engine 335 selects the keyword associated with the highest expected value.

Based on the selected keyword, the keyword selection engine 335 generates a link that is included with the post provided to the requesting user. As discussed above in conjunction with FIG. 1, the link may be a hyperlink to a website associated with the selected keyword, a hyperlink to a search landing page resulting from a contextual search query generated from the selected keyword, or a link to any other suitable content based on the selected keyword.

The value calculation module 350 creates and updates the expected values stored in the value store 340 or in the keyword store 340. For example, the value calculation module 350 monitors accesses to a link generated from a keyword and notifies the expected value of the keyword accordingly. Additionally, the value calculation module 350 may categorize and update expected values based on the characteristics of users accessing links generated from various keywords to update user categories associated with a keyword.

The web server 355 links the social networking system 104 via the network 210 to the one or more client devices 105, as well as to the one or more data sources 205. The web server 355 serves web pages, as well as other web-related content, such as JAVA®, FLASH®, XML and so forth. The web server 355 may receive and route messages between the social networking system 104 and a client device 105, for example, instant messages, queued messages (e.g., email), text and SMS (short message service) messages, content items for posting, posts, or messages sent using any other suitable messaging technique. A user may send a request to the web server 355 to upload information, for example, images or videos that are stored in the content store 310 or some other content item. Additionally, the web server 355 may provide API functionality to send data directly to native client device operating systems, such as IOS®, ANDROID™, WEBOS® or a similar embedded operating system.

Association of Keywords with Content Items in a Social Networking System

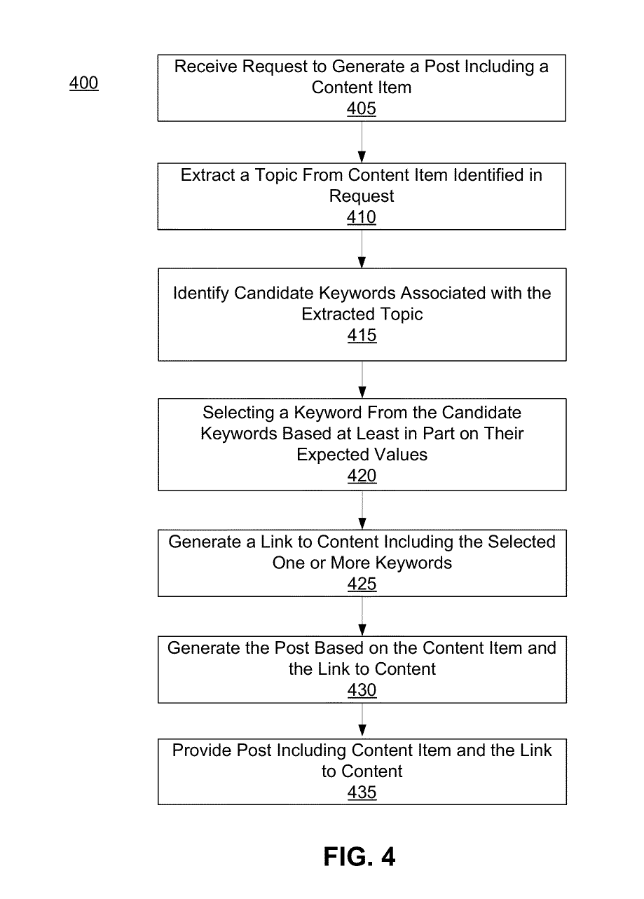

FIG. 4 flowchart of one embodiment of a process 400 for associating a keyword with a post in a social networking system 104. A request to generate a post including a content item is received 405 from a user. For example, the social networking system 104 receives 405 a request to provide a user of the client device 105 with a post including a content item.

The social networking system 104 extracts 410 a topic from the content item identified in the request. As discussed above in conjunction with FIGS. 1 and 3, the social networking system 104 may identify anchor terms from the content item and extract 410 a topic based on the anchor terms as further described in U.S. application Ser. No. 13/167,701, filed Jun. 24, 2011, and U.S. patent application Ser. No. 13/627,945, filed on Sep. 26, 2012, which are each hereby incorporated by reference in their entirety. In other embodiments, the social networking system 104 may extract 410 a topic from the content item using any suitable technique. Based on the extracted topic, the social networking system 104 identifies 415 one or more candidate keywords. The one or more candidate keywords are associated with the extracted topic and are each associated with an expected value.

The social networking system 104 selects 420 a keyword from the candidate keywords based at least in part on the expected values associated with the candidate keywords. In one embodiment, the social networking system 104 retrieves user information associated with the user requesting the post and compares the retrieved user information to characteristics associated with one or more user categories. Expected values associated with the candidate keywords and with a user category having the largest number of characteristics satisfied by the user information are retrieved and used to select 420 the keyword. In one embodiment, the social networking system 104 ranks the candidate keywords using the expected values and selects the candidate keyword associated with the highest expected value.

Alternatively, the social networking system 104 retrieves an expected value for each of the candidate keywords that are associated with the extracted topic. Hence, each candidate keyword may have multiple expected values each associated with a different topic. In some embodiments if the candidate keyword is the same or similar to the topic, the social networking system 104 selects 420 the candidate keyword matching, or having a threshold similarity to, the extracted topic.

Based on the selected keyword, the social networking system 104 generates 425 a link to content based on the selected keyword. As discussed above in conjunction with FIG. 1, the link may be a hyperlink to a website associated with the selected keyword, or a hyperlink to a search landing page including results from a contextual search based on the selected keyword that results from a search engine performing a search using the selected keyword. A post including the generated link and the content item is generated 430 and provided 435 to the client device 105 associated with the user. The client device 105 presents the post, which includes the content item and the generated link to content, to the user

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a request to generate a post including a content item for presentation through a social networking system from a device associated with a user of the social networking system;
extracting a topic from the content item;
identifying one or more candidate keywords associated with the extracted topic from keywords maintained by the social networking system;
determining an expected value associated with each of the candidate keywords;
ranking the candidate keywords based at least in part on the expected values associated with the candidate keywords;
selecting a keyword from the identified candidate keywords based on the ranking;
generating a link to content based on the selected keyword;
generating the post including the content item and the link to content; and
providing the post to the device for presentation of the content item the link to content to the user.

2. The method of claim 1, wherein determining an expected value associated with each of the candidate keywords comprises:
retrieving user information from the social networking system describing one or more characteristics of the user;
comparing the user information with one or more user categories associated with each candidate keyword, each user category associated with one or more characteristics; and
retrieving an expected value associated with a candidate keyword and associated with a user category having a largest number of characteristics satisfied by the retrieved user information

3. The method of claim 2, wherein the retrieved user information includes one or more characteristics of additional users connected to the user in the social networking system.

4. The method of claim 2, further comprising:
receiving an additional request to generate the post from an additional device associated with an additional user of the social networking system;
retrieving user information describing one or more characteristics of the additional user from the social networking system;
comparing the user information describing the one or more characteristics of the additional user with one or more user categories associated with each candidate keyword, each user category associated with one or more characteristics;
retrieving an additional expected value associated with a candidate keyword and associated with a user category having a largest number of characteristics satisfied by the r the user information describing the one or more characteristics of the additional user;
ranking the candidate keywords based on the additional expected values associated with the candidate keywords;
selecting a keyword for the additional user from the identified candidate keywords based on the ranking, based on the additional expected values;
generating a link to content based on keyword for the additional user;
generating an additional post based on the content item and the link to content; and
providing the post to the additional device associated with the additional user for presenting the content item and the link to content to the additional user.

5. The method of claim 4, wherein the link to content identifies the same content for the user and for the additional user.

6. The method of claim 1, further comprising:
monitoring whether the user accesses the link; and
updating the expected value associated with the selected keyword based on whether the user accesses the link.

7. The method of claim 1, wherein the expected value associated with a candidate keyword is a product of an advertisement bid price associated with the candidate keyword and a probability of the user accessing the candidate keyword.

8. The method of claim 1, wherein the expected value associated with a candidate keyword is based at least in part on the topic.

9. The method of claim 1, wherein the link is selected from the group consisting of: a hyperlink to a website associated with the selected keyword, a hyperlink to a search landing page including search results based on the selected keyword, and any combination thereof.

10. The method of claim 9, wherein the search landing page contains an advertisement.

11. A method comprising:
receiving a request to generate a post including a content item for presentation through a social networking system from a device associated with a user of the social networking system;
extracting a topic from the content item;
identifying candidate keywords associated with the extracted topic from keywords maintained by the social networking system, each keyword associated with one or more expected values associated one or more user categories;
retrieving user information from the social networking system describing one or more characteristics of the user;
comparing the user information with one or more user categories associated with each expected value
retrieving an expected value associated with a candidate keyword and associated with a user category having a largest number of characteristics satisfied by the retrieved user information
ranking the candidate keywords based on the retrieved expected values associated with the candidate keywords;
selecting a keyword from the identified candidate keywords based on the ranking;
generating a link to content based on the selected keyword;
generating the post including the content item and the link to content; and
providing the post to the device for presentation of the content item and the link to content to the user.

12. The method of claim 11, wherein the retrieved user information includes one or more characteristics of additional users connected to the user in the social networking system

13. The method of claim 11, further comprising:
monitoring whether the user accesses link; and
updating the expected value associated with the selected keyword and associated with the user category having a largest number of characteristics satisfied by the retrieved user information based on whether the user accesses the link.

14. The method of claim 11, wherein the expected value associated with a candidate keyword and with a user category is a product of an advertisement bid price associated with the candidate keyword and a probability of the user accessing the candidate keyword.

15. The method of claim 11, wherein the link is selected from the group consisting of: a hyperlink to a website associated with the selected keyword, a hyperlink to a search landing page including search results based on the selected keyword, and any combination thereof.

16. The method of claim 15, wherein the search landing page contains an advertisement.

17. A method comprising:
receiving a request to generate a post including a content item for presentation through a social networking system from a device associated with a user of the social networking system;
extracting a topic from the content item;
identifying candidate keywords associated with the extracted topic from keywords maintained by the social networking system, each keyword associated with one or more expected values associated with different topics;
retrieving expected values of each of the candidate advertisements associated with the extracted topic;
ranking the candidate keywords based on the expected values associated with the candidate keywords;
selecting a keyword from the identified candidate keywords based on the ranking;
generating a link to content based on the selected keyword;
generating the post including the content item and the link to content; and
providing the post to the device for presentation of the content item and the link to content to the user.

18. The method of claim 17, wherein the link is selected from the group consisting of: a hyperlink to a website associated with the selected keyword, a hyperlink to a search landing page including search results based on the selected keyword, and any combination thereof.

19. The method of claim 17, wherein the search landing page contains an advertisement.

20. The method of claim 17, further comprising:
monitoring whether the user accesses the link; and
updating the expected value associated with the selected keyword based on whether the user accesses the link.
